(19) United States
(12) Patent Application Publication
(10) Pub. No.: US 2017/0370522 A1
(43) Pub. Date: Dec. 28, 2017

(54) Garment Mount System

(71) Applicant: Robert Schield, Belleville, IL (US)

(72) Inventor: Robert Schield, Belleville, IL (US)

(21) Appl. No.: 15/635,013

(22) Filed: Jun. 27, 2017

Related U.S. Application Data
(60) Provisional application No. 62/354,884, filed on Jun. 27, 2016.

(51) Int. Cl. F16M 13/04; A45F 5/02; A41D 1/00; A62B 17/00; G03B 17/56; F16B 1/00

(52) U.S. Cl. CPC F16M 13/04; G03B 17/561; F16B 1/00; A41D 1/002; A62B 17/003; A45F 5/02; F16B 2001/0035

(57) ABSTRACT

A mounting system for mounting an accessory on garments is disclosed. The mounting system may be used for mounting body worn cameras on fire jackets, police tactical vests and police shirts.

### CROSS REFERENCE TO RELATED APPLICATION[S]

This application is claims priority to U.S. Provisional Patent Application entitled “GARMENT MOUNTING SYSTEM,” Ser. No. 62/354,884, filed Jun. 27, 2016, the disclosure of which is hereby incorporated entirely herein by reference.

### BACKGROUND OF THE INVENTION

### Technical Field

This invention relates to a mounting system for an accessory on a garment. More particularly, the invention relates to a mounting system for a body-worn camera on a garment.

### State of the Art

Police and fire departments are routinely relying on the use of accessories, such as, for example, body cameras, in day to day operations. The body cameras may be very expensive. Accordingly, what is needed is a garment mounting system wherein the accessory, such as a body-worn camera, becomes securely mounted on the garment and cannot easily fall off, be stolen and/or dropped.

### DISCLOSURE OF THE INVENTION

The disclosed invention relates to a mounting system for an accessory, such as a body camera, on a garment.

Disclosed is a garment mounting system for mounting an accessory on a garment comprising: a garment attachment means and an accessory attachment means.

Also disclosed is a method of using a garment mounting system for mounting an accessory on a garment, comprising the steps of: attaching a clip to the garment, wherein the clip comprises a plurality of magnets on a bottom surface; and, attaching the bottom surface of the clip to a metal back surface of an accessory.

Also disclosed is a method of using a garment mounting system for mounting an accessory on a garment comprising the steps of: attaching a garment mount to the garment, wherein the garment mount comprises an enlarged, open ended slot; attaching an accessory mount to an accessory, wherein the accessory mount comprises an enlarged button having a plurality of serrations on a top surface; and, coupling said accessory mount to said garment mount, wherein said enlarged, open ended slot receives said enlarged button.

In an embodiment, the garment mounting system may be used for any garment, including but not limited to a fire jacket, police uniform shirt, and a police tactical vest.

In an embodiment, the garment mounting system as described herein may be used to mount any conventional accessory on a garment, such as, for example, a body-worn camera. The garment mount clips to, or encloses a portion of a layer of the garment. The accessory, such as a body worn camera, becomes a part of the garment and therefore cannot be dropped, stolen and/or fall off.

The foregoing and other features and advantages of the invention will be apparent to those of ordinary skill in the art from the following more particular description of the invention and the accompanying drawings.

### BRIEF DESCRIPTION OF THE DRAWINGS

FIG. 1 shows a front view of a garment mount in a first embodiment according to the present invention.

FIG. 2 shows a rear view of a garment mount in a first embodiment according to the present invention.

FIG. 3 shows a side view of a garment mount fastened to a piece of fabric.

FIG. 4 shows a front view of an accessory mount in a first embodiment according to the invention.

FIG. 5 shows a side view of an accessory mount in a first embodiment according to the invention.

FIG. 6 shows a side view of an accessory mount on a body-worn camera in a first embodiment according to the invention.

FIG. 7 shows a front view of an accessory mount, in a first embodiment, coupled to a body camera according to the invention.

FIG. 8 shows a side view of a garment mount in a second embodiment according to the invention.

FIG. 9 shows a rear view of an accessory mount in a second embodiment according to the invention.

FIG. 10 shows a side view of a garment mount on a body camera in a second embodiment according to the invention.

FIG. 11 shows a front view of a garment mount in a first embodiment coupled to a garment according to the present invention.

FIG. 12 shows a front view of a camera mounted to a garment according to a second embodiment of the present invention.

FIG. 13 shows a front vie of a camera mounted to a garment according to the invention.

### DETAILED DESCRIPTION OF EMBODIMENTS OF THE INVENTION

As discussed above, embodiments of the present invention relate to a garment mounting system for an accessory, such as a body camera.

In one embodiment, the garment mount attaches to the garment in a manner similar to a clothing security sensor. The garment mount may be placed on a garment using special prongs that are designed to avoid damaging the garment. The garment mount is also designed to be difficult to remove without the proper tool, or without damaging the garment. The garment mount may be removed or detached, for example, using a powerful magnet, a key, and/or a combination of both. The garment mount may be two pieces and may include a pin that inserts through the garment and then is secured to the garment by means of a plastic back attached to the pin.

In a second embodiment, the garment mount attaches to the garment in a manner similar to a clip, such as an alligator clip. The garment mount may be clipped on the garment. Magnets on the bottom surface of the clip attach to a metal plate mounted on the accessory.

The garment mount can be reused and applied to a variety of garments. The garment mount may be any desired shape and/or size for use on a variety of garments.

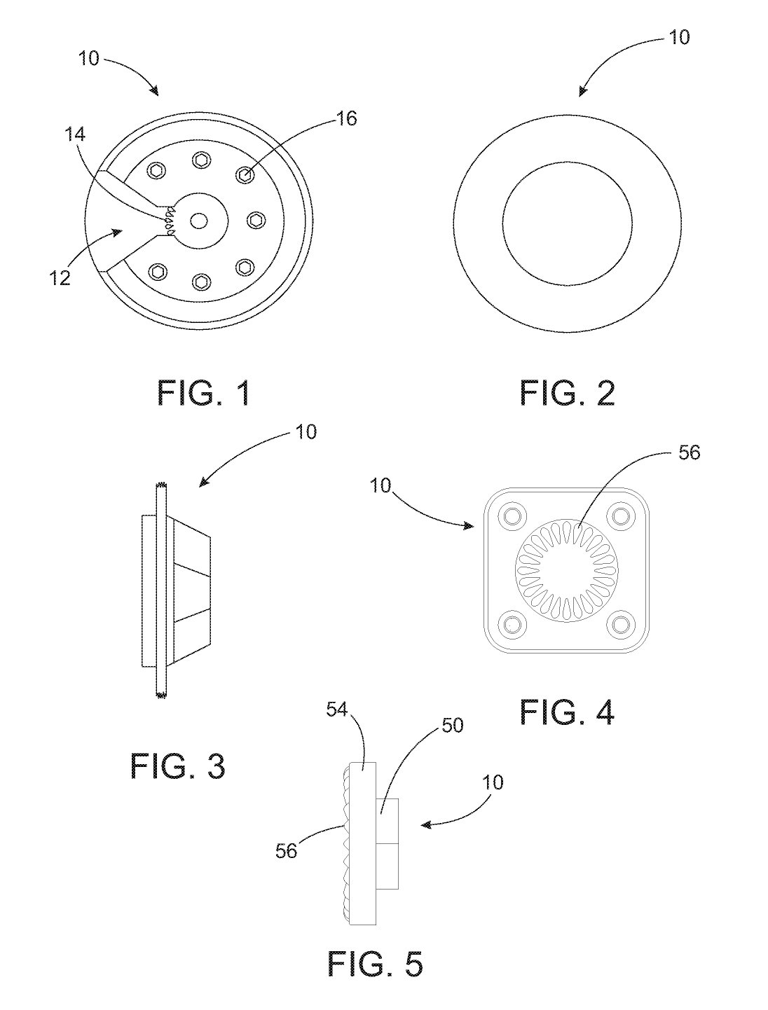

FIG. 1 shows circular garment mount 10 having an enlarged, open ended slot 12 with serrations 14 and a plurality of magnets 16. FIG. 2 shows the rear of garment mount 10. In an embodiment, garment mount 10 includes a pin (not shown) protruding from the rear of garment mount 10 approximately perpendicular to the rear surface of garment mount 10, and is secured to a layer of clothing by pushing the pin through the layer of clothing such that it protrudes through the layer of clothing, and securing the protruding portion of the pin by means of a plastic back that attaches to the protruding pin. FIG. 3 generally illustrates a side-view of a garment mount 10 that has been secured to a piece of clothing by means of such a protruding pin and plastic back.

FIG. 4 shows a front view of an accessory mount in a first embodiment according to the invention. The accessory mount is configured to be attached to a variety of accessories.

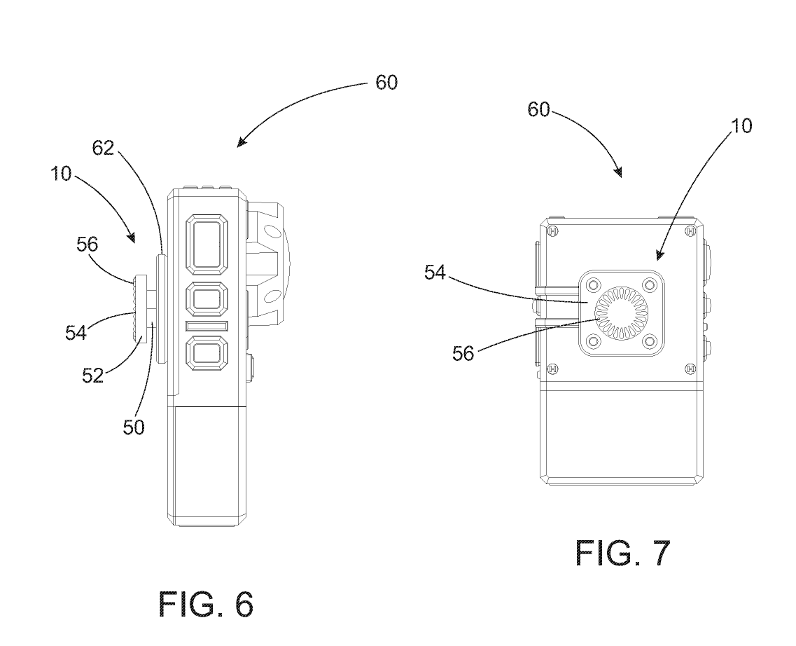

As shown in FIGS. 5 and 6, body worn camera 60 is coupled via coupling means 62 to enlarged button 50 of an accessory mount. Top surface 54 of button 50 includes a plurality of serrations 56 and stem head 52. Enlarged button 50 of the accessory mount and open-ended slot 12 of garment mount 10 are configured such that garment mount 10 receives and removably secures button 50, thereby securely coupling body worn camera 60 to a garment.

FIG. 7 shows a front view of an accessory mount of FIG. 4, in which the accessory mount is coupled to a body camera according to an embodiment of the invention.

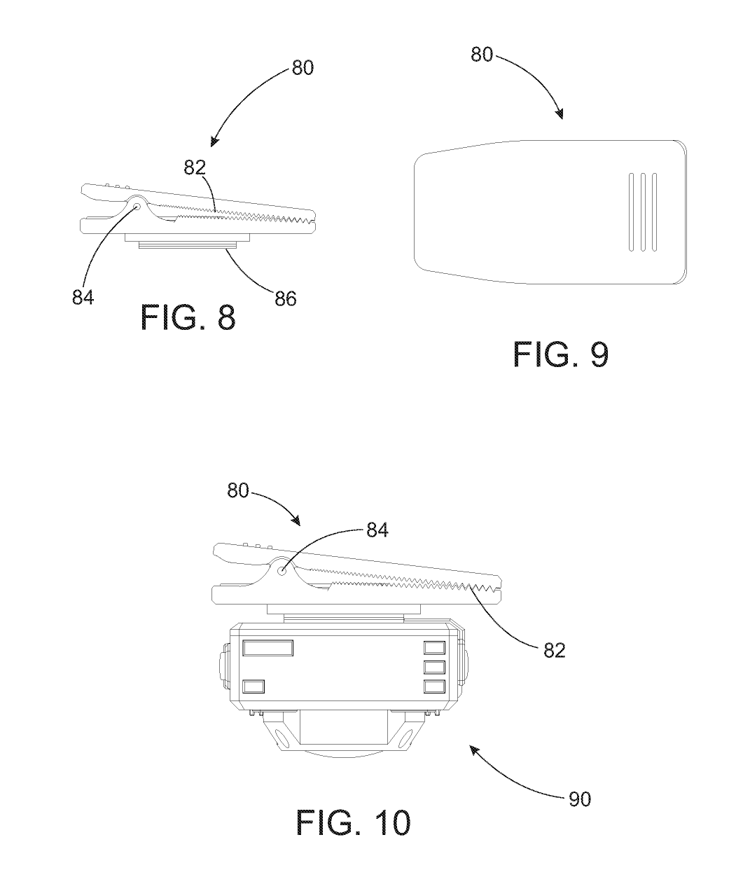

FIGS. 8 to 10 show alligator clip garment mount 80 having serrations 82 and a spring pivot 84 which clips on a garment. The bottom surface of alligator clip garment mount 80 has a plurality of magnets 86 which magnetically attach to the back metal surface of camera 90, securing the camera to the garment mount 80, and any clothing to which garment mount 80 is secured.

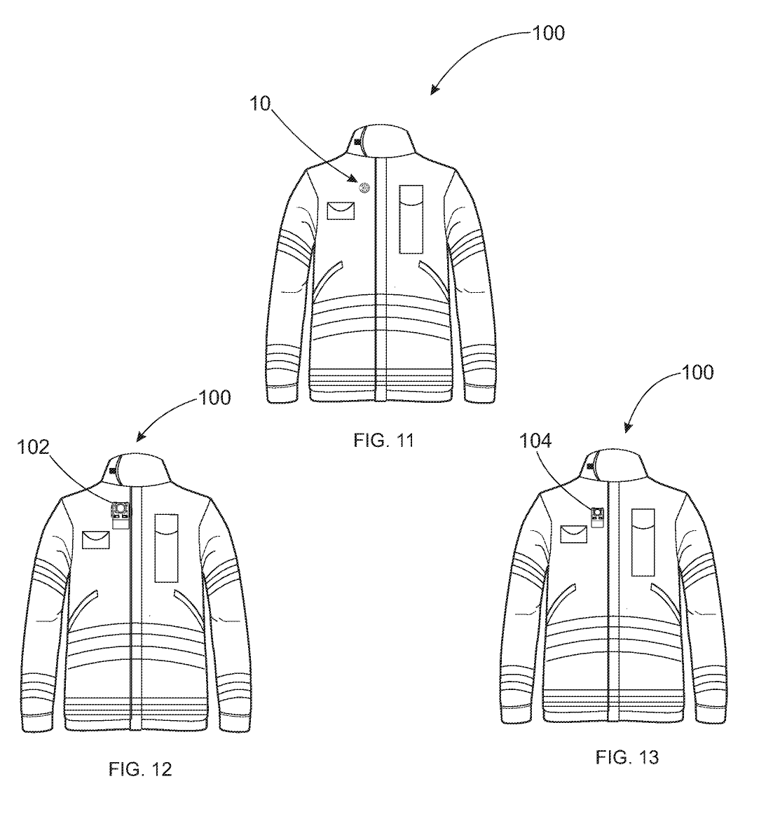

As shown in FIGS. 11 to 13, garment mount 10 is coupled to fire jacket 100. Body worn cameras in two sizes, 102 and 104, are coupled to fire jacket 100 via garment mount 10.

The embodiments and examples set forth herein were presented in order to best explain the present invention and its practical application, and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

What is claimed:

1. A garment mounting system for mounting an accessory on a garment comprising: a garment attachment means and an accessory attachment means.

2. The garment mounting system of claim 1, wherein the accessory is a body worn camera.

3. The garment mounting system of claim 1, wherein the garment is a fire jacket.

4. The garment mounting system of claim 1, wherein the garment attachment means comprises a clip.

5. The garment mounting system of claim 4, wherein the clip is an alligator clip.

6. The garment mounting system of claim 1, wherein the accessory attachment means comprises a plurality of magnets.

7. The garment mounting system of claim 1, wherein the garment attachment means comprises a pin.

8. The garment mounting system of claim 1, wherein the garment attachment means comprises a plurality of magnets.

9. The garment mounting system of claim 1, wherein the garment attachment means comprises an enlarged, open ended slot.

10. The garment mounting system of claim 9, wherein the enlarged, open ended slot comprises serrations.

11. The garment mounting system of claim 1, wherein the accessory attachment means comprises an enlarged button having a stem head.

12. The garment mounting system of claim 11, wherein a top surface of the enlarged button has a plurality of serrations.

13. A method of using a garment mounting system for mounting an accessory on a garment comprising:
attaching a clip to the garment, wherein the clip comprises a plurality of magnets on a bottom surface; and
attaching the bottom surface of the clip to a metal back surface of an accessory.

14. A method of using a garment mounting system for mounting an accessory on a garment comprising:
attaching a garment mount to the garment, wherein the garment mount comprises an enlarged, open ended slot;
attaching an accessory mount to an accessory, wherein the accessory mount comprises an enlarged button having a plurality of serrations on a top surface; and
coupling said accessory mount to said garment mount, wherein said enlarged, open ended slot receives said enlarged button.
